(19) United States
(12) Patent Application Publication
(10) Pub. No.: US 2026/0310626 A1
(43) Pub. Date: Oct. 8, 2026

(54) UART MODE VIA HIGHSPEED PROTOCOL

(71) Applicants: Advanced Micro Devices, Inc., Santa Clara, CA (US); ATI Technologies ULC, Markham (CA)

(72) Inventors: Shaofeng An, Ontario (CA); Michael Tresidder, Willow City, TX (US); YanFeng Wang, Ontario (CA); David Alan Brown, Ontario (CA)

(73) Assignees: Advanced Micro Devices, Inc., Santa Clara, CA (US); ATI Technologies ULC, Markham (CA)

(21) Appl. No.: 19/425,639

(22) Filed: Dec. 18, 2025

Related U.S. Application Data
(60) Provisional application No. 63/783,693, filed on Apr. 4, 2025.

(51) Int. Cl. G06F 13/42; G06F 13/38

(52) U.S. Cl. CPC G06F 13/4282; G06F 13/382

(57) ABSTRACT

Systems and devices for Universal Asynchronous Receiver Transmitter (UART) mode communication may include a first circuit including a first receiver transmitter in communication with a second receiver transmitter of a second circuit over an interconnect link. In a transmit direction, the first circuit is configured to pack stream transport data into data flits of a datagram for serialized transmission of data from the first receiver transmitter to the second receiver transmitter over the interconnect link. In a receive direction, the first circuit is configured to unpack the stream transport data from the data flits received as serialized data over the interconnect link from the second circuit of the second receiver transmitter. The stream transport data can be firmware data packed into the data flits as data link messages, which may be exchanged between firmware agents associated with the respective first circuit and second circuit.

### CROSS-REFERENCE TO RELATED APPLICATIONS

The present application claims priority to and benefit of U.S. Provisional Patent Application No. 63/783,693, filed Apr. 4, 2025, and entitled “UART MODE VIA HIGHSPEED PROTOCOL,” the entirety of which is herein incorporated by reference.

### BACKGROUND

Accelerators are commonly used in computing systems such as, for example, processing nodes in data centers to perform a wide range of demanding processing tasks such as, for example, computations, model inferencing, storage, and other applications. Many applications require real-time or near real-time results, which may be achieved by multiple processing nodes working together through data communication and resource sharing to perform common tasks. Accordingly, providing high-speed, low-latency communications over an interconnect fabric between accelerators plays a critical role in capitalizing on the full potential of these systems.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings make apparent to those skilled in the art how embodiments of the disclosure may be practiced.

FIG. 1 is a block diagram of an exemplary system, according to some embodiments.

FIG. 2 is a diagram of an exemplary system, according to some embodiments.

FIG. 3 is a block diagram of an exemplary system, according to some embodiments.

FIG. 4 is a block diagram of an exemplary system configured to implement the techniques described herein, according to some embodiments.

FIG. 5 is an example diagram of a UART mode communication system, according to some embodiments.

FIG. 6 is an example diagram of a portion of an exemplary communication system for implementing the UART mode communications, according to some embodiments.

FIG. 7 is an exemplary datagram for carrying a UART message, according to some embodiments.

FIG. 8 is an exemplary segment header for indicating a content of a datagram including a UART message, according to some embodiments.

FIG. 9 is an exemplary method for performing data exchange in accordance with an exemplary UART mode communication protocol, according to some embodiments.

### DETAILED DESCRIPTION

Described herein are systems, apparatuses, and methods related to Universal Asynchronous Receiver/Transmitters (UARTs) mode communication between two host computing systems over an interconnect fabric, which may in some embodiments be implemented with circuitry including UARTs for serialized data transmissions between respective link partners (e.g., firmware agents of two host computing systems) to enable vendor defined communications between the link partners. Systems may in some embodiments include the UART mode communication as described herein to provide a hardware driven credit-based flow control across the interconnect link using the DL flits to prevent receiver (RX) buffer overflow. The UART mode communication may in some embodiments be used for security purposes.

Prior approaches for UART communication between link partners either require a dedicated interface or are limited to relatively short distances. Some prior approaches for UART mode communication may utilize a general purpose input/output (GPIO) on an integrated circuit. However, these prior approaches are only capable of simple interrupt based handshakes and typically require a dedicated interface to build a communication channel. Some other prior approaches utilize low speed protocol circuitry such as Inter-Integrated Circuit (I2C) or Serial Peripheral Interface (SPI). However, these prior approaches are limited to short distance communications such as, for example, within a single device and are not capable of supporting communication between two computing systems that are a certain distance apart from each other without demonstrating poor signal quality and communication errors. Some other prior approaches utilize certain high speed protocols using, for example, analog fiber links (e.g., wafl/twix links). However, these approaches require a dedicated protocol to build the communication channel, which may limit the scalability and interoperability with other computing systems or interfaces.

Some approaches to UART mode communication as described herein may provide a bi-directional protocol for data transmission over an interconnect link without necessitating a dedicated protocol for the vendor defined communications. UART mode communication between link partners may include inserting UART mode communication may in some embodiments be implemented by sending UART stream transport messages as data layer (“DL”) messages by packing the UART stream transport messages into DL flow control units (“flit”) for serialized transmission over the interconnect link between a UART transmit buffer on one end of the interconnect link and a UART receive buffer at the other end of the interconnect link. Utilizing DL flits for high speed communications of the UART stream transport messages over the interconnect fabric or link can support the link partners (e.g., firmware agents of the link partners) in the exchange of a data stream with a defined data length with minimal bandwidth impact and without the need to use the dedicated protocol, thereby improving upon prior conventional approaches as described herein.

The UART stream transport messages may be packed into DL flits. In some examples, a system may include circuitry that can encode data for transmission over the interconnect fabric in accordance with a high-speed communication protocol as described herein, and the circuitry can be designed to pack the UART stream transport messages into the DL flits. Each DL flit may in some embodiments include a plurality of segments, and each segment of the plurality of segment may include a DL alternative sector. Each segment may include a segment header, which may include data having a value to indicate that a given segment of the DL flit includes a DL alternative sector for communication of DL messages between the link partners. The UART stream transport messages can be packed into the DL alternative sector of a given segment, and the respective segment header can have a value or values indicating that the DL alternative sector includes the DL message. The DL alternative sector may only be a fraction of the total size of the given segment. For example, a segment of a DL flit may be 1024-bits and a DL alternative segment may be 4 B or 32-bits.

UART mode communication may in some embodiments be used to provide hardware driven credit-based flow control across the link by using the DL messages to prevent receiver buffer overflow. In some embodiments, UART mode communication may be used to dynamically determine a length of a UART stream transport message as a function of available credits and UART transmit buffer fill. UART stream transport messages may in some embodiments be represented as double words (Dwords) to indicate the length of the message and for the message itself. UART stream transport messages may in some embodiments have a variable length, and the length of a given UART stream transport message may be indicated in a first Dword. The first Dword may not be stored in the UART transmit buffer or the UART receive buffer. Subsequent Dwords of the UART stream transport message after the first Dword may be the message data itself, which may be stored in the UART transmit buffer and stored in the UART receive buffer when received from the transmitter. In some examples, the UART transmit buffer and the UART receive buffer may store 128 Dwords each, per stream. The UART mode communication may in some embodiments include a single defined stream. The UART mode communication may in some embodiments include up to 8 streams in the stream ID fields.

In some embodiments, an apparatus includes: a first circuit, the first circuit includes a first receiver transmitter configured to asynchronously communicate with a second receiver transmitter of a second circuit over an interconnect link. In a transmit direction, the first circuit is configured to pack stream transport data into a first data flits of outgoing datagrams for serialized transmission of data from the first receiver transmitter to the second receiver transmitter over the interconnect link. In a receive direction, the first circuit is configured to unpack stream transport data from a second data flits of incoming datagrams received as serialized data over the interconnect link from the second circuit of the second receiver transmitter.

In some embodiments, the first receiver transmitter includes: a transmit buffer for storing data messages to be packed into the first data flits and sent to the second receiver transmitter over the interconnect link, and a receive buffer for storing data messages from the second data flits received over the interconnect link from the second receiver transmitter.

In some embodiments, the apparatus further includes: a first firmware agent. The first firmware agent exchanges data messages with a second firmware agent of the second receiver transmitter. The first firmware agent stores the data messages onto the transmit buffer, and the first firmware agent reads the data messages stored on the receive buffer.

In some embodiments, the first firmware agent and the second firmware agent exchange data messages to perform a firmware update.

In some embodiments, the apparatus further includes: a first serializer/deserializer (SERDES) coupled between the first receiver transmitter and the interconnect link. The first SERDES receives datagrams as parallel data and converts it to serialized data for transmission to a second SERDES coupled to the second receiver transmitter over the interconnect link.

In some embodiments, the first and second data flits include: a header, a cyclic redundancy check, and a plurality of segments for storing a data payload. The stream transport data is stored in at least one segment of the plurality of segments.

In some embodiments, each segment of the plurality of segments includes: a segment header and an alternate sector. The stream transport data is stored in the alternate sector. Responsive to a given segment having data stored in the alternate sector, the segment header includes a field value characterizing data being stored in the alternate sector.

In some embodiments, the alternate sector is 32-bits. In some embodiments, each segment is 1024-bits.

In some embodiments, the stream transport data includes: a first Dword characterizing a size of the stream transport data and at least one second Dword characterizing a data payload of the stream transport data. The first Dword is determined based on a credit-based flow control for storing Dwords in a receiver buffer of the second receiver transmitter. The at least one second Dword is stored at a transmit buffer of the first receiver transmitter for the first circuit to pack into the first data flits.

In some embodiments, a system for exchanging data messages between computing devices over an interconnect fabric in accordance with a protocol, the system includes: a first computing device including a first receiver transmitter, the first computing device coupled to the interconnect fabric; and a second computing device including a second receiver transmitter, the second computing device coupled to the interconnect fabric. In a transmit direction, the first receiver transmitter is configured to pack stream transport data from a transmit buffer into data flits of outgoing datagrams for transmission from the first receiver transmitter to the second receiver transmitter of the second computing device over the interconnect fabric. In a receive direction, the first receiver transmitter is configured to unpack stream transport data from data flits of incoming datagrams received over the interconnect fabric from the second receiver transmitter of the second computing device and stores the stream transport data in a receive buffer.

In some embodiments, the first computing device further includes a first firmware agent, the second computing device further includes a second firmware agent, and the first firmware agent is configured to exchange data messages with the second firmware agent. The first firmware agent and the second firmware agent each store the data messages to be sent to the other of the first firmware agent and the second firmware agent onto the respective transmit buffer, and the first firmware agent and the second firmware agent each read the data messages stored on the respective receive buffer.

In some embodiments, the first firmware agent and the second firmware agent exchange data messages to perform a firmware update.

In some embodiments, the first computing device further includes a first serializer/deserializer (SERDES) coupled between the first receiver transmitter and the interconnect fabric, the second computing device further includes a second SERDES coupled between the second receiver transmitter and the interconnect fabric. The first SERDES receives the outgoing datagrams as parallel data and converts it to serialized data for transmission to the second SERDES over the interconnect fabric, and the second SERDES receives the serialized data over the interconnect fabric and converts the serialized data to the incoming datagrams as parallel data for storing into the respective receive buffer of the second receiver transmitter.

In some embodiments, the data flits include: a header, a cyclic redundancy check, and a plurality of segments for storing a data payload. Each segment includes: a segment header, and an alternate sector. Stream transport data is stored in the alternate sector. Responsive to a given segment having data stored in the alternate sector, the segment header includes a field value characterizing data being stored in the alternate sector.

In some embodiments, the alternate sector is 32-bits, and each segment is 1024-bits.

In some embodiments, stream transport data includes: a first Dword characterizing a size of the stream transport data, and at least one second Dword characterizing a data payload of the stream transport data. The first Dword is determined based on a credit-based flow control for storing Dwords in a receiver buffer of the second receiver transmitter. The at least one second Dword is stored at the transmit buffer of the first receiver transmitter to pack into the data flits of the outgoing datagrams.

In some embodiments, a method includes: receiving, by a first circuit, a first stream transport message at a transmit buffer; packing, by the first circuit, the first stream transport message into a data flit of a first datagram; and converting, by the first circuit, the first datagram from a parallel data to a serialized data for transmission over an interconnect link to a second receiver transmitter.

In some embodiments, packing, by the first circuit, the first stream transport message into the data flit of the first datagram further includes: determining, by the first circuit, a size of the first stream transport message; generating, by the first circuit, a first Dword characterizing the size of the first stream transport message; and packing, by the first circuit, the first Dword and at least one second Dword into one or more data flits of the first datagram for transmission over the interconnect link to the second receiver transmitter.

In some embodiments, packing, by the first circuit, the first Dword and the at least one second Dword into the one or more data flits of the first datagram further includes: packing, by the first circuit, the first Dword and the at least one second Dword of the first stream transport message into one or more alternate sectors of the one or more data flits of the first datagram, and encoding, for each alternate sector including the first stream transport message, a field value characterizing data being stored in the each alternate sector in a corresponding segment header. Each data flit includes a plurality of segments, and each segment includes an alternate sector.

In some embodiments, the method further includes: converting, by a second circuit, the serialized data received from the interconnect link to parallel data and sending the first datagram from the parallel data to the second receiver transmitter; unpacking, by the second circuit, the first stream transport message from the data flit of the first datagram; and storing, by the second circuit, the first stream transport message at a receiver buffer.

Among those benefits and improvements that have been disclosed in the foregoing, other objects and advantages of this disclosure will become apparent from the following description taken in conjunction with the accompanying figures. Detailed embodiments are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

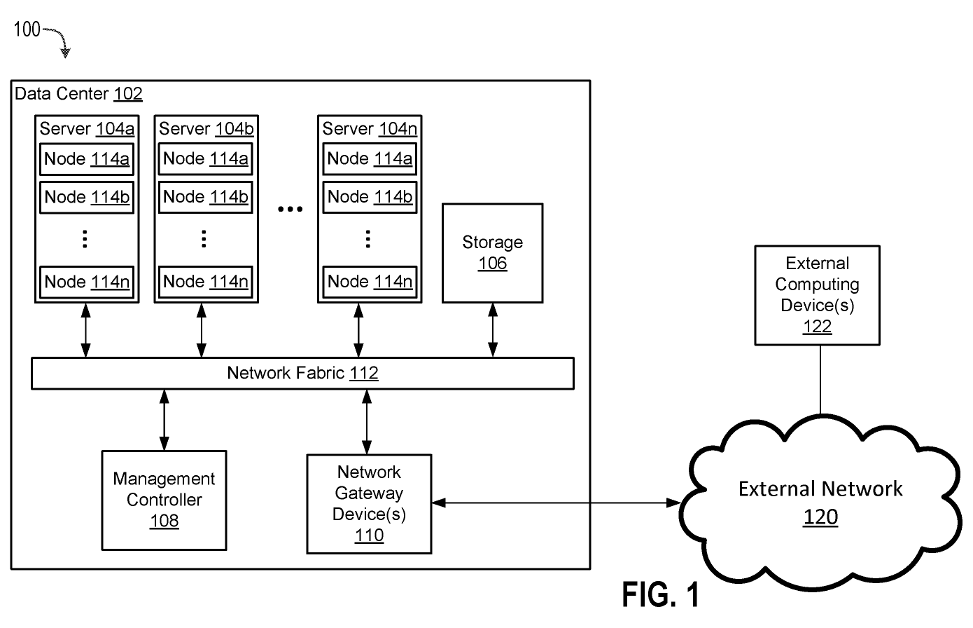

FIG. 1 illustrates a block diagram of an exemplary system 100, according to some embodiments. The system 100 may be configured to implement some techniques described herein, although other systems are possible.

Referring to FIG. 1, the system 100 may include a data center 102. The data center 102 may be communicatively connected to an external network 120. The data center 102 may, for example, receive processing requests from external computing device(s) 122 via the external network 120. The data center 102 may be utilized to perform any of a plurality of processing or rendering tasks based on one or more data sets using at least some portion of a processing and rendering resources of data center 102. For example, a user of an external computing device 122 may send a processing request to data center 102 via external network 120, and the data center 102 may utilize one or more of the processing resources of data center 102 to fulfill the user request. It should be appreciated that FIG. 1 is intended neither to be a depiction of necessary components for a data center or components thereof to operate in accordance with the principles described herein, nor a comprehensive depiction. The system 100 can include additional components, omit one or more of the described components, multiple instances of a component even if only one instance is shown in FIG. 1), and/or can be organized in other suitable manners.

In some examples, the data center 102 may include a plurality of servers 104, storage device(s) 106, management controller 108, and a network gateway device(s) 110. Each of the plurality of servers 104, storage device(s) 106, management controller 108, and network gateway device(s) 110 may be communicatively coupled with one or more other components of the data center 102 over a network fabric 112.

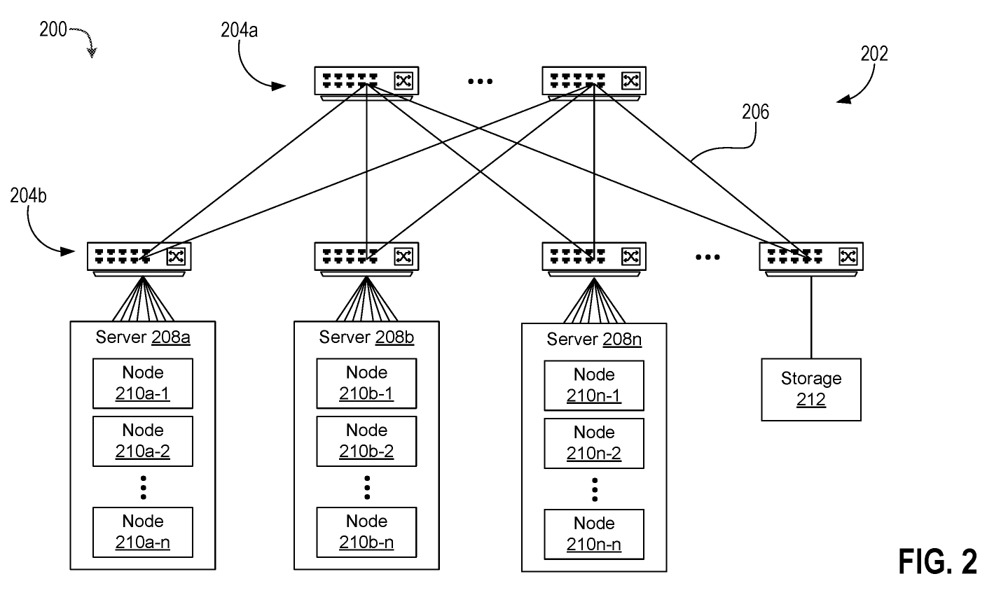

The plurality of servers 104 may include servers 104a, 104b, through 104n. Each server 104a, 104b, through 104n may include a plurality of processing nodes 114, each of the plurality of processing nodes 114 including one or more processing resources for performing processing or rendering tasks, as will be further described herein. While the examples of FIGS. 1 and 2 illustrate servers 104 that include processing nodes 114, in other embodiments each processing nodes 114 may include processing and storage resources and may be directly connected to network fabric 112, such that there may not be any element considered to be a server 104 or such that each processing node 114 may be considered a separate server 104.

The storage device(s) 106 may include a variety of computer-readable media for storing data, programs, instructions, etc. for use by the plurality of processing nodes 114 of the plurality of servers 104. For example, storage device(s) 106 can include any combination of random access memory (RAM), read only memory (ROM); electronically erasable programmable read only memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the plurality of processing nodes 114. The storage device(s) 106 can include computer-storage media in the form of volatile and/or nonvolatile memory. The storage device(s) 106 may be removable, non-removable, or any combination thereof. For example, storage device(s) 106 can include hardware devices such as hard drives, solid-state memory, optical-disc drives, and the like.

The management controller 108 may be connected to each of the plurality of servers 104, storage device(s) 106, network gateway device(s) 110. Each of the plurality of servers 104 (shown as servers 104a, 104b, through 104n) may include a plurality of processing nodes 114 (shown as nodes 114a, 114b, through 114n). The management controller 108 may include a combination of hardware, software and firmware to assist in orchestration of processing operations using the plurality of processing nodes 114 at each of the plurality of servers 104, which may include controlling storage, communications, timing, frequency, etc. within the data center 102 and/or between parts of the plurality of servers 104 and other systems (e.g., external client devices).

The network gateway device(s) 110 may communicatively connect data center 102 to external network 120, which may be used to enable external computing device(s) 122 to send processing requests to data center 102, and to receive data from data center 102 responsive to the request via external network 120. For example, network gateway device(s) 110 may receive a processing request from a user of an external computing device 122 via external network 120, and the network gateway device(s) 110 may transmit the request to management controller 108 to orchestrate fulfillment of the request using one or more of the plurality of processing nodes 114 of the plurality of servers 104 in accordance with the user request.

FIG. 2 illustrates a diagram of an exemplary system 200, according to some embodiments. The system 200 may be configured to implement some techniques described herein, although other systems are possible. System 200 may be implemented with any combination of components and/or subsystems of system 100.

It should be appreciated that FIG. 2 is intended neither to be a depiction of necessary components for a data center or components thereof to operate in accordance with the principles described herein, nor a comprehensive depiction. The system 200 can include additional components, omit one or more of the described components, multiple instances of a component even if only one instance is shown in FIG. 2), and/or can be organized in other suitable manners.

In some examples, system 200 may include a network fabric 202 coupled to one or more components including a plurality of servers 208 (shown as servers 208a, 208b, through 208n). The one or more other components may include any of the components or sub-systems of system 100. Each of the plurality of servers 208 may include a plurality of nodes 210 for fulfilling processing tasks received from, for example, management controller 108 of FIG. 1. For example, referring to FIG. 2, server 208a may include nodes 210a-1, node 210a-2, through node 210a-n. For example, the one or more other components of system 200 may include storage 212, which may be connected to network fabric 202 to enable the plurality of servers 208 and the plurality of processing nodes 210 of each of the plurality of servers 208 to store and retrieve data from storage 212.

The network fabric 202 may include a plurality of switches 204 interconnected together via one or more interconnect links 206 such that each switch 204 of the plurality of switches 204 may be connected to one or more other components of system 200. In some examples, the plurality of switches 204 of network fabric 202 may include spine switches 204a and leaf switches 204b. The spine switches 204a may be used to interconnect one or more leaf switches 204b. The leaf switches 204b may interconnect one or more servers to the spine switches 204a. The leaf switches 204b may serve as an access switch that aggregates data traffic from servers and forwards the data to the spine switches 204a for transmission to its intended destination. The leaf switches 204b may be referred to as top-of-rack switches, and which may be used to connect to the plurality of processing nodes 210 of a given server 208 to enable data transmission and resource sharing between the plurality of processing nodes 210 of the given server 208 and/or data transmission and resource sharing between nodes 210 of respective servers of the plurality of servers 208.

The interconnect links 206 be used for serialized data transmission between at least two components of system 200 over one or more lanes at a defined serial rate. In some examples, one or more of the interconnect links 206 may be defined in accordance with 200 Gigabit communication standard. In some embodiments the one or more of the interconnect links 206 may be defined for 1, 2, or 4 serial lanes capable of running at a serial rate of 212.5 Gbps. For example, the interconnect links 206 may be designed in accordance with 200GBASE-KR1/CR1, 400GBASE-KR2/CR2, and/or 800GBASE-KR4/CR4 standards. In some examples, one or more of the interconnect links 206 may be defined in accordance with 100 Gigabit communication standard. In some embodiments the one or more of the interconnect links 206 may be defined for 1, 2, or 4 serial lanes capable of running at a serial rate of 212.5 Gbps. For example, the interconnect links 206 may be designed in accordance with 100GBASE-KR1/CR1, 200GBASE-KR2/CR2, 400GBASE-KR4/CR4 standards.

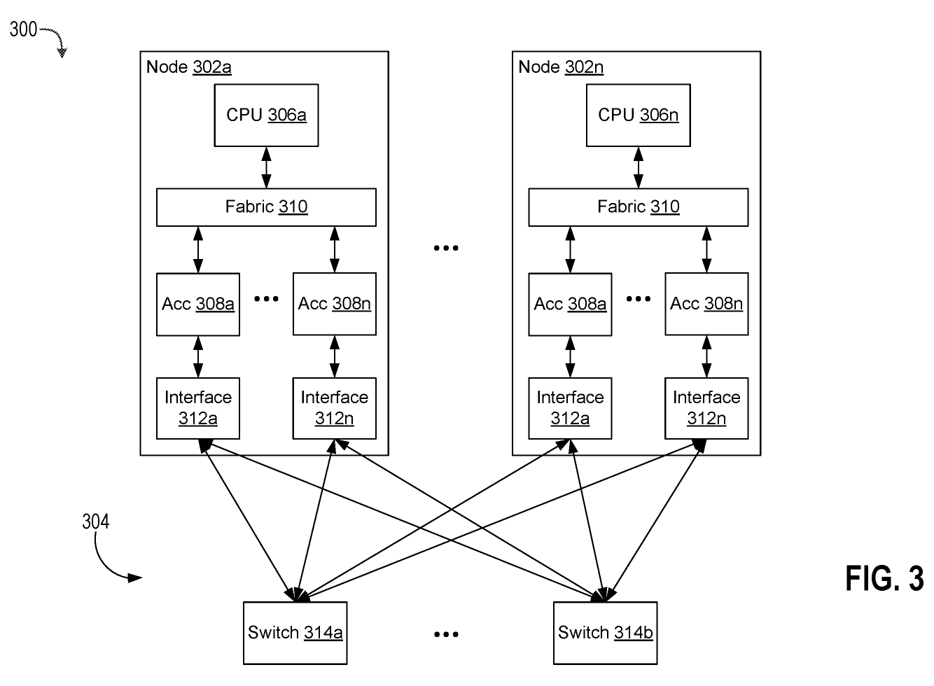

FIG. 3 illustrates a block diagram of an exemplary system 300, according to some embodiments. The system 300 may be configured to implement the techniques described herein, although other systems are possible. System 300 may be implemented with any combination of components and/or subsystems of system 100 and system 200.

System 300 may include one or more processing nodes 302 (shown as processing node 302a through processing node 302n). Each processing node 302 may be coupled to one or more other components of system 300 over an interconnect fabric 304. In some examples, each processing node 302 may be connected to one or more other processing nodes 302 over interconnect fabric 304 for data transmission and resource sharing purposes. In some examples, each processing nodes 302 may be selectively utilized to perform a processing or rendering operation either discretely or in parallel with one or more other processing nodes 302 in accordance with some orchestration scheme as determined by, for example, management controller 108 of FIG. 1.

In some examples, processing node 302 may include a host central processing unit (CPU) 306 (shown as CPUs 306a through 306n), a plurality of accelerators 308 (shown as accelerators 308a through 308n), all communicatively attached through host fabric 310 (or other connection circuitry). In some examples, the CPU 306, plurality of accelerators 308, and data fabric 310 may be coupled to (e.g., mounted on) a printed circuit board (e.g., motherboard).

The CPU 306 may be configured to process data and execute instructions of an operating system and/or instructions (e.g., program code) of one or more applications. In some examples, the functionality of the program code may be implemented by one or more of the CPU 306, one or more processor chiplets of a CPU 306, and/or one or more cores of a processor chiplet of a CPU 306. The data and instructions can be stored on a memory (not shown) coupled to CPU 306. The data and instructions can comprise computer-executable instructions implementing any suitable functionality.

In some examples, as part of executing a given software application, the CPU 306 launches rendering tasks to be performed on the plurality of accelerators 308. It should be appreciated that although FIG. 3 shows plurality of accelerators 308, the processing node 302 may include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc.), or a combination thereof.

In some examples, a host fabric 310 connects CPU 306 and plurality of accelerators 308, and other components within the processing node 302. The host fabric 310 may include any type of communication fabric, bus, and/or other control and interface logic for facilitating the communication of data between various components of the processing node 302. For example, the host fabric 310 may include data paths, switches, routers, and other logic used to communicate data among the various components. In some embodiments, the host fabric 310 may be bus-based, including shared bus configurations, crossbar configurations, and hierarchical buses with bridges. host fabric 310 may also be packet-based, and can be hierarchical with bridges, crossbar, point-to-point, or other interconnects.

In some examples, each processing node 302 may further include one or more interface devices 312 (shown as interface 312a through 312n). The one or more interface devices 312 may be used to communicatively connect the accelerators 308 of a processing node 302 to one or more other accelerators 308 of another processing node 302 for data transmission and resource sharing purposes over interconnect fabric 304. For example, one or more accelerators 308 of processing node 302a may be connected to the one or more accelerators 308 of processing node 302n over the interconnect fabric 304 for data transmission and resource sharing. For example, the one or more interface devices 312 may be network interface cards (“NICs”) for connecting the plurality of accelerators 308 of processing node 302 to the interconnect fabric 304 and one or more other components of the system 300. In some examples, interconnect fabric 304 may include a plurality of switches including at least switch 314a and 314b, and one or more of the plurality of accelerators 308 of processing node 302a may be communication connected to one or more of the plurality of accelerators 308 of processing node 302n through at least one of switch 314a and switch 314b of interconnect fabric 304.

It should be appreciated that system 300 of FIG. 3 may further include one or more interface devices (e.g., NICs), and each CPU 306 may be connected to a respective interface device to enable front-end communication between the processing node 302 and one or more other components of system 300 over the interconnect fabric 304. For example, management controller 108 may send processing instructions to CPU 306 through the respective interface device.

It should be appreciated that FIG. 3 is intended neither to be a depiction of necessary components for a processing node or components thereof to operate in accordance with the principles described herein, nor a comprehensive depiction. The system 300 can include additional components, omit one or more of the described components, multiple instances of a component even if only one instance is shown in FIG. 3, and/or can be organized in other suitable manners.

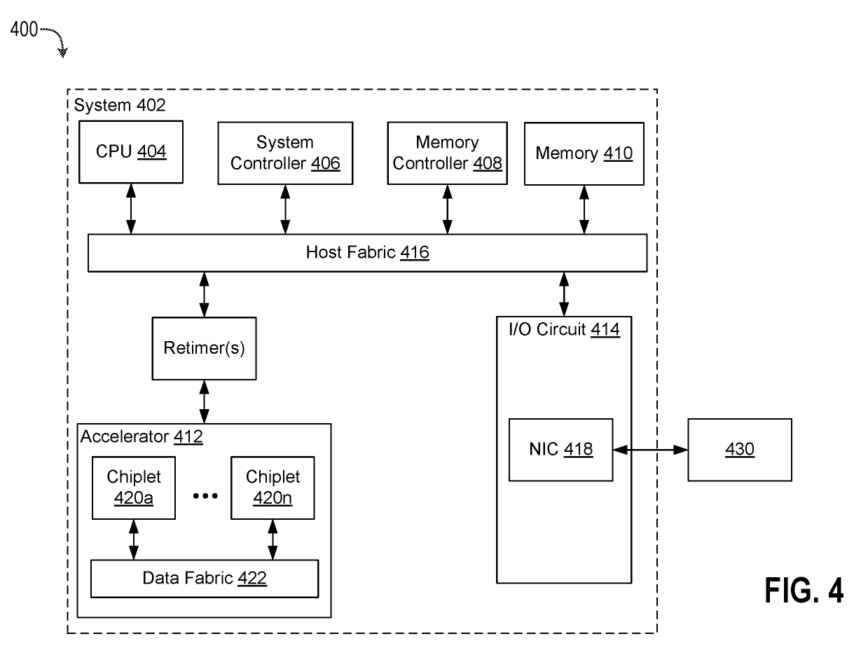

FIG. 4 is a block diagram of an exemplary system 400 configured to implement the techniques described herein, according to some embodiments. The system 400 may be configured to implement some techniques described herein, although other systems are possible. System 400 may be implemented with any combination of components and/or subsystems of system 100, system 200, and system 300.

System 400 may include a computer system 402. Computer system 402 may be or otherwise be included within, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. It should be appreciated that FIG. 4 is intended neither to be a depiction of necessary components for a computer system or device to operate in accordance with the principles described herein, nor a comprehensive depiction. The computer system 400 can include additional components, omit one or more of the described components, multiple instances of a component even if only one instance is shown in FIG. 4, and/or can be organized in other suitable manners.

In some examples, the computer system 402 may be a processing node, which may include a central processing unit (CPU) 404, a system controller 406, a memory controller 408, a memory 410, an accelerator 412, and an I/O circuit 414, which may each be communicatively attached through host fabric 416 (or other connection circuitry). In some examples, the CPU 404, system controller 406, accelerator 412, memory 410, and host fabric 416 are coupled to (e.g., mounted on) a printed circuit board (e.g., motherboard).

The CPU 404 can include any combination of processing units, for example, one or more processor chiplets, each including one or more cores. In some examples, the processor chiplets (or other processing units) can communicate with each other via interconnects routed through or on a package substrate. The CPU 404 is configured to process data and execute instructions of an operating system and/or instructions (e.g., program code) of one or more applications. In some examples, the functionality of the program code may be implemented by one or more of the CPU 404, one or more processor chiplets of a CPU 404, one or more cores of a processor chiplet, and/or the accelerator 412. The data and instructions can be stored on memory 410. The data and instructions stored on any of the computer-readable storage media (e.g., memory 410, registers, internal or external of the CPU 404, caches of the accelerator 412, etc.) can comprise computer-executable instructions implementing any suitable functionality.

The memory 410 can include a variety of computer-readable media for storing data, programs, instructions, etc. for use by the computer system 402. For example, memory 410 can include any combination of random access memory (RAM), read only memory (ROM); electronically erasable programmable read only memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the CPU 404 and/or the accelerator 412. The memory 410 can include computer-storage media in the form of volatile and/or nonvolatile memory. The memory 410 may be removable, non-removable, or any combination thereof. For example, memory 410 can include hardware devices such as hard drives, solid-state memory, optical-disc drives, and the like.

In some examples, as part of executing a given software application, the CPU 404 launches rendering tasks to be performed on the accelerator 412. The accelerator 412 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc.), or a combination thereof.

In some examples, a host fabric 416 connects CPU 404, memory 410 (directly of via one or more memory controllers 408), accelerator 412, I/O circuitry 414, and other components within the system 402. The host fabric 416, can include any type of communication fabric, bus, and/or other control and interface logic for facilitating the communication of data between various components of the computer system 402. For example, the host fabric 416 can include data paths, switches, routers, and other logic used to communicate data among the various components. In some embodiments, the host fabric 416 can be bus-based, including shared bus configurations, crossbar configurations, and hierarchical buses with bridges. Host fabric 416 can also be packet-based, and can be hierarchical with bridges, crossbar, point-to-point, or other interconnects. The host fabric 416 is configured to route memory access requests and memory responses between any memory accessing components and/or the one or more memory controllers 408. The host fabric 416 can also include a system memory map (e.g., defined by BIOS) for determining destinations of memory accesses based on the system configuration.

In some examples, the computer system 402 includes a system controller 406, which may include one or more circuits. Each of the CPU 404, the memory 410 (directly of via one or more memory controllers 408), the accelerator 412, host fabric 416, and the I/O circuitry 414 can be bidirectionally connected to a system controller 406 (or power management controller), which forms a control fabric and is configured to provide memory access requests to host fabric 416. The system controller 406 can include a combination of hardware, software and firmware to assist in controlling storage, communications, timing, frequency, etc. within the computer system 402 and/or between parts of the computer system 402 and other systems (e.g., client devices).

For example, the system controller 406 manages power-up sequencing of the various processors and includes one or more clock sources (e.g., a phase locked loop (PLL)), to provide clock signals for each of the components of the computer system 402. The system controller 406 also manages power for the various processors and other functional blocks, and may receive measured power consumption values from CPU 404 and accelerator 412 to determine appropriate power states. The computer system 402 also implements various system monitoring and power saving functions, for example, thermal monitoring. The computer system 402 can assist in tracking mitigating action based on such monitoring. For example, if the computer system 402 becomes hot, then system controller 406 can reduce the frequency and voltage of CPU 404 and/or accelerator 412 or shut down the computer system 402 entirely. In some examples, the system controller 406 can control and/or trigger proactive and/or reactive mitigation actions to be taken based on monitored criteria. For example, the system controller 406 initiate proactive dynamic workload control and/or reactive “big hammer” actions such as drastic clock frequency reduction.

The one or more memory controllers 408 are configured to control the flow of data to and from the memory 410. For example, the memory controller 408 can handle the reading and writing of data to and from the memory 410, schedule access to the memory 410 to optimize bandwidth and latency, detect and correct errors in data stored in memory, translate logical addresses into physical addresses, adjust the use of available memory bandwidth to maximize performance, among other tasks.

In some examples, the I/O circuitry 414 may be configured to physically connect and communicatively with one or more other components. In some examples, the I/O circuitry 414 may include a network interface card (NIC) 418 to connect the computer system 402 to an interconnect fabric 430 of a network system such as, for example and without limitation, system 100 of FIG. 1. In some examples, the NIC 418 may be a standalone card separate from the I/O circuitry 414.

In some examples, the I/O circuitry 414 may be configured to physically connect to peripheral devices and control the flow of data to and from the memory 410 and/or storage. Some non-limiting examples of an input device can include a mouse, keyboard, scanner, video game controller, microphone, webcam, etc. Some non-limiting examples of an output device can include a display, printer, speakers, headphones, earbuds, etc. The I/O circuitry 414 can include any suitable type of peripheral connector(s), including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc. In some examples, portions of the I/O circuitry 414 can be integrated into a motherboard and/or motherboard chipset (e.g., I/O circuitry 414) of the computer system 402.

As described above, computer system 402 may have one or more components and peripherals, including input and output devices. These devices may be used, among other things, to present a user interface. Examples of output devices that can be used to provide a user interface include display screens for visual presentation.

In some examples, the accelerator 412 may include any combination of processing units, for example, one or more processor chiplets, each including one or more cores. In some examples, the processor chiplets (or other processing units) can communicate with each other via a data fabric 422 comprising interconnects internally routed between each of the chiplets 420a through 420n of accelerator 412. Each chiplet 420 may in some examples be packaged from one or more dies, and the header modification techniques described herein may be implemented to enable data transmission between the chiplets 420. The interconnects may in some embodiments be routed through or on a package substrate to connect the chiplets 420a through 420n. The accelerator 412 may be configured to process data and execute instructions of CPU 404 and/or instructions (e.g., program code) of one or more applications. In some examples, the functionality of the program code may be implemented by one or more of the accelerators 412, one or more processor chiplets of accelerator 412, one or more cores of a processor chiplet, and/or the CPU 404. The data and instructions may be stored on memory 410 and/or memory (not shown). The data and instructions stored on any of the computer-readable storage media (e.g., memory 410, registers, internal or external of the CPU 404, caches of the processing unit 420, etc.) can comprise computer-executable instructions implementing any suitable functionality.

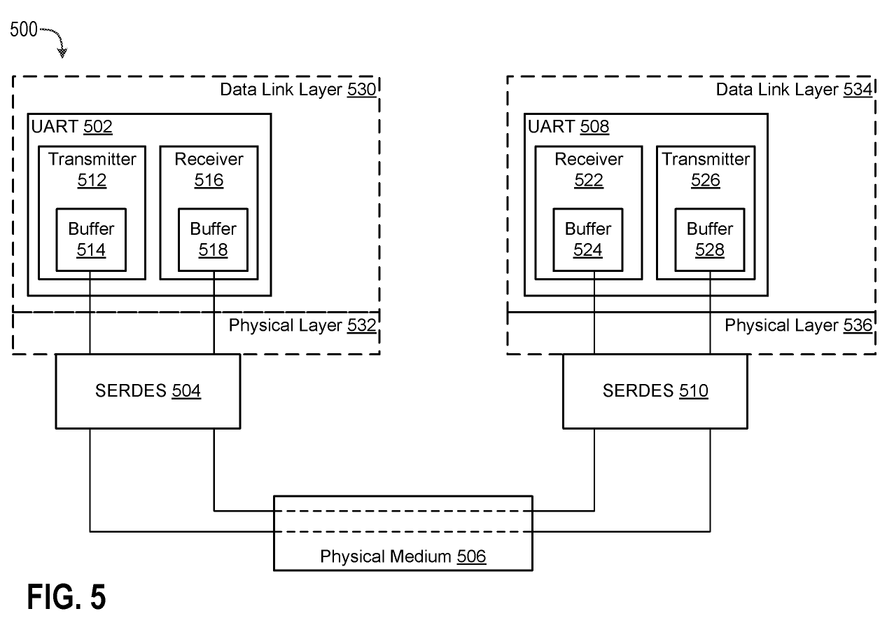

FIG. 5 illustrates an example diagram of a UART mode communication system 500, according to some embodiments. The UART mode communication system 500 may be configured to implement the techniques described herein, although other systems are possible. UART mode communication system 500 may be implemented with any combination of components and/or subsystems of system 100, system 200, system 300, and system 400.

It should be appreciated that FIG. 5 is intended neither to be a depiction of necessary components for the UART mode communication system 500 to operate in accordance with the principles described herein, nor a comprehensive depiction. The UART mode communication system 500 may include additional components, omit one or more of the described components, multiple instances of a component even if only one instance is shown in FIG. 5, and/or can be organized in other suitable manners.

The UART mode communication system 500 may be configured to enable vendor defined communication between link partners. The communications may include DL messages (DL to DL messages), which may be inserted into alternate segments that are packed into the DL flit payload, along with TL flit data. DL messages provide support for firmware message sequencing using the UART. DL messages may in some embodiments also provide support for negotiating channel online/offline states, advertising transaction layer (TL) rates, and requesting link partners device ID and port number. In some examples, the negotiated channel states may include channel 0 for TL flits and channel 4 for DL UART messages. In some examples, security may also make use of the UART mode communication. For example, UART mode communication may be used to exchange key pair data for encrypting data. It should be appreciated that the UART mode communication system 500 may be utilized for other types of communication between UARTs for the asynchronous transmission of streaming data over one or more serial lanes of an interconnect link without necessitating a dedicated protocol, in accordance with some examples described herein. For example, the UART mode communication system 500 may be used to stream data between link partners including, for example and without limitation, handshake signals, DL messages, data payloads, firmware messages, key pair data for encrypting data, among other types of data used with UART mode communication. In some examples, the UART mode communication system 500 may be used to enable two firmware agents of respective processing nodes that are link partners across the interconnect link to exchange firmware data over a communication channel.

The UART mode communication system 500 may be implemented with any combination of components or subsystems of system 400 and/or computer system 402 of FIG. 4. In some embodiments, UART mode communication system 500 may be implemented with any combination of components or sub-systems of computer system 402 of FIG. 4. In some examples, UART mode communication system 500 may be implemented in computer system 402 between CPU 404 and another CPU as link partners across interconnect fabric 430 of FIG. 4. In other examples, UART mode communication system 500 may be implemented at computer system 402 between accelerator 412 and another accelerator located in another computer system as link partners across interconnect fabric 430 as shown in FIG. 4. In yet other examples, UART mode communication system 500 may be implemented at computer system 402 between NIC 418 and another NIC as link partners across the interconnect fabric 430. It should be appreciated that the component(s) or subsystem(s) being utilized to implement the UART mode communications may vary depending on the processing and transmission that is being performed in the respective transmit or receive direction. For example, the UART mode communication can be implemented over host fabric 416 and NIC 418 and embodied as circuitry for data transmission over one or more serial lanes of an interconnect link of interconnect fabric 430 coupled to NIC 418.

Referring to FIG. 5, the UART mode communication system 500 may be between link partners. A first link partner may include a UART 502 coupled to a serializer/deserializer (SERDES) 504. The SERDES 504 may be coupled to UART 502 and physical medium 506 for serialized transmission of data packets to a second link partner and receiving data packets from the second link partner. The second link partner may be coupled across the physical medium 506 from the first link partner and may include a UART 508 coupled to a SERDES 510. The SERDES 510 may be coupled to UART 508 and physical medium 506 for serialized transmission of data packets to the first link partner and receiving data packets from the first link partner. The data packets transmitted over the physical medium 506 may be based on the stream transport messages from a respective one of the UART 502 and UART 508. In some examples, the stream transport messages from UART 502 may be packed into DL flits and transmitted to the second link partner across the physical medium 506, and UART 508 may receive stream transport messages based on the data received over the physical medium 506 from UART 502.

The UART 502 may include a transmitter 512 having a transmit buffer 514 for transmitting an asynchronous data stream to the SERDES 504 for serialized data transmission over the physical medium 506 to UART 508. The UART 502 may include receiver 516 having a receive buffer 518 for receiving deserialized data from SERDES 504 that was received from UART 508 over the physical medium 506. Similar to UART 502, UART 508 may include a transmitter 526 having a transmit buffer 528 for transmitting an asynchronous data stream to the SERDES 510 for serialized data transmission over the physical medium 506 to UART 502. The UART 508 may include receiver 522 having a receive buffer 524 for receiving deserialized data from SERDES 510 that was received from UART 502 over the physical medium 506.

In some examples, the UART 502 may be implemented in accordance with a communication protocol of the system 400 and/or computer system 402, which may in some embodiments be implemented as a computer architecture including one or more logical layers capable of performing UART mode communications in accordance with the techniques described herein. The logical layers of the first link partner may include a data layer 530 and a physical layer 532, among other layers. The logical layers of the second link partner may include a data layer 532 and a physical layer 536, among other layers. Each of these logical layers may include any suitable combination of hardware, software, or firmware, for managing and executing commands (instructions, requests, signals, etc.) as part of a processing pipeline for communications between UART 502 and UART 508 over physical medium 506, as will be further described herein.

In some examples, commands for execution may include transmitter 512 of UART 502 transmitting the UART data stream as DL messages and packing them into DL flits for transmission as serialized data over the physical medium 506. In some examples, commands for execution may also include SERDES 504 receiving serialized data from physical medium 506 and decoding them as DL messages and sending the data to the receiver 516 of the UART 502. In some examples, in band DL to DL messages may be supported via alternate segments that are packed into the 640-byte DL flit payload, along with the TL flit data payloads, as will be further described herein. DL to DL messages may provide support for firmware message sequencing via UART, negotiating channel online/offline, advertising transaction layer rates, and requesting link partners information such as, for example, Device ID and port number. In some examples, channel online messages may include channel 0 may be used for TL Flits and channel 4 may be used for DL UART messages.

Each link partner may include a firmware agent, which may utilize the UART mode communication system 500 to exchange firmware messages as UART stream transport messages with the other firmware agent of the other link partner. In some examples, a firmware agent of a first link partner writes some data to the UART TX buffer (buffer 514), and the data is inserted into the DL flit at a transmitting DL and transmitted to a second link partner. The receiving DL removes the data from the DL flit and places it in the UART RX buffer (buffer 524). A firmware agent of the second link partner reads the data.

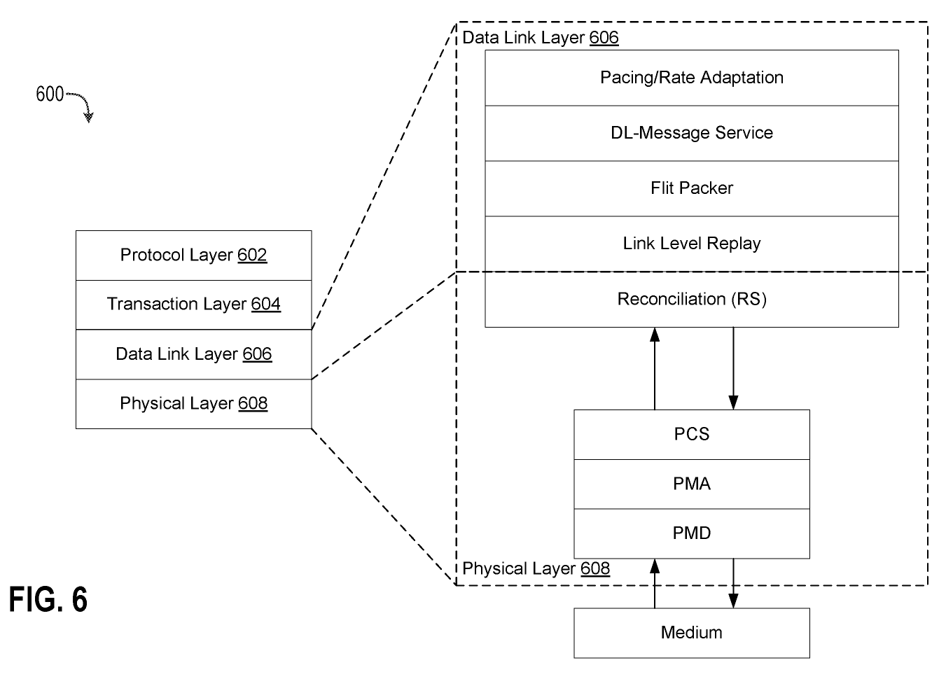

FIG. 6 illustrates an example diagram of a portion of an exemplary communication system 600 for implementing the UART mode communications, according to some embodiments. The communication system 600 may be configured to implement the techniques described herein, although other systems are possible. Communication system 600 may be implemented with any combination of components and/or subsystems of system 100, system 200, system 300, system 400, and UART mode communication system 500.

The communication system 600 described herein may be designed to facilitate UART mode communications by transmitting an asynchronous data stream between UARTs such as, for example, between UART 502 and UART 508 of FIG. 5, which may be encoded as data link (DL) messages and packed into DL flits for transmission as datagrams over a medium such as, for example, physical medium 506 of FIG. 5. This communication may be structured in accordance with a protocol, which may in some embodiments include one or more layers, and each layer may include one or more sub-layers, to ensure robust and efficient data exchange between the link partners.

In some examples, system architecture of communication system 600 may include a protocol layer (PL) 602, a transaction layer (TL) 604, a data link layer (DL) 606, and a physical layer (PHY) 608. Each of these layers may be logical layers of a protocol responsible for specific functions that collectively enable seamless communication between link partners. The communication system 600 may carry messages being exchanged between a sender and receiver and over a physical medium in accordance with the layers of communication system 600. In addition, the communication system 600 may be a symmetrical protocol with the same set of messages and channels supported in both transmit and receive paths. During communication, these messages may traverse through multiple functional layers of the communication system 600 in the journey between originator and transmitter.

The PL 602 may define a logical signaling interface and a protocol by which devices can exchange data and control information through a set of Request and Response messages. The PL 602 of communication system 600 may define the protocol and may expect implementations that follow this protocol will be compatible with the interconnect fabric such as, for example, network fabric 112. The communication system 600 may include built-in flexibility to allow vendors to create custom protocol messages for communication between processing units without any modification to the interconnect switches.

The TL 604 may be coupled to two PL interfaces (not shown), one interface may be communicatively coupled to an originator device via PL 602 and the other interface may be communicatively coupled to a completer device via PL 602 (not shown). The TL 604 may drive a 64-byte Outbound Transmit (TX) Flit to the DL 606 and may receive from the DL 606 a 64-byte Inbound Receive (RX) Flit. The channels driven into the TL 604 from both interfaces may be packaged into 64-byte Outbound Transmit (TX) Flits, which may be transmitted to the DL 606. Similarly, the Receive (RX) 64-byte TL Flit from the DL 606 may be unpacked into Request, Read Response/Data, Orig Data, and Write Response channels for the two interfaces coupled to the TL 604, which may be transmitted to one of the originator or completer devices.

The DL 606 may receive 64B Flits from the TL 604 and may package these Flits into 640B Flits in the transmit direction and may send them to the PHY 608. Similarly, in the receive direction the DL 606 may receive 640B Flits from the PHY 608 and unpacks then into 64B Flits and then sends them to the TL 604. The DL 606 may provide a control message service used for coordinating changes to the link, i.e., online/offline, and other features.

In some examples, the DL 606 may provide a UART mechanism for firmware-controlled sequences to be passed as DL messages across the link to enable vendor defined communication between link partners. Referring to FIG. 5, in some examples, the UART mechanism may provide a communication path between UART 502 and UART 508 for exchanging firmware messages. For example, the UART mechanism may provide communication channels between firmware agents on both sides of the given link. Hardware driven credit-based flow control may be provided across the link via DL messages to prevent RX buffer overflow. Security may also make use of the UART. For example, referring again to FIG. 5, a firmware agent may be the originator that writes to the UART 502 TX buffer 514, and the data may be inserted into the DL Flit(s) and transmitted to SERDES 504 for serialized transmission to the link partner over the physical medium 506. The receiving DL 534 may remove the data from the DL Flit and place it in the UART 508 RX buffer 524. Firmware may be the completer on the receiving side that reads the data from stored at RX buffer 524.

The PHY 608 may support one or more rates of serial communication over an interconnet link between two link partners. In some examples, the PHY 608 may support 200G serial transmission including, for example and without limitation, 200GBASE-KR1/CR1, 400GBASE-KR2/CR2, and 800GBASEKR4/ CR4. In some examples, the PHY 608 may also support 100G serial transmission including, for example and without limitation, 100 GBASE-KR1/CR1, 200 GBASE-KR2/CR2, 400 GBASE-KR4/CR4. To reduce latency at the 200G serial rates, 1-way and 2- way code word interleave modes may be supported, in addition to the standard 4-way interleave.

To improve latency each DL Flit may be packed uniquely into a single 680-Byte code word. The additional 40-bytes may be for FEC overhead and 256B/257B line coding. Achieving DL Flit to code word alignment may not require changes to a standard Ethernet PCS, regarding alignment marker insertion and removal. That is, in some examples, the alignment markers on the wire(s) may be unchanged from IEEE 802.3 definition. Instead, only the mechanism for how the alignment markers may be inserted and removed may be modified to enable a reconciliation sub-layer to decide when to start the sequences for sending the alignment markers.

In some examples, ethernet retimers may also be compatible provided they use the recovered clock for forwarding the data. This is the most common mechanism. Adding or removing idle codes may require FEC decode and encode and may incur a large latency penalty. In addition, this may break the DL Flit to code word association required for seamless and efficient communication over the interconnect link by communication system 600. Auto negotiation and link training may also be unchanged from 802.3 Ethernet PCS.

In some examples, the UART may provide a mechanism for sending data across the interconnect link between a UART transmit buffer on one end and a UART Receive Buffer on the other end at a fraction of the link bandwidth, and which may be provided as a bidirectional protocol. The firmware data may be packed into DL flits for transmission to the other firmware agent of the other link partner over the interconnect link. Each DL flit may be a 640B flit and may include multiple segments. Each segment may include an alternate sector for storing up to 32-bits of data as DL messages, and which can be used to store the UART stream transport messages. Each segment is 1024-bits, thus approximately 3% of the link bandwidth may be utilized for UART stream transport messages. The UART stream transport messages may be DWords. The UART stream transport messages may have a variable length, and the length may be indicated in the first DWord of the UART stream transport message. The first DWord may not be stored in the UART transmit buffer or UART Receiver Buffer. The length of the UART Stream Transport Message may be determined dynamically as a function of available credits and UART transmit buffer fill. Subsequent Dwords may include the message data and may be stored in the respective UART transmit buffer and UART receiver buffer during the communication process. In some examples, the UART transmit buffer and UART Receive Buffer may store 128 Dwords each, per stream. In some examples, a single stream may be defined. However, in some examples, up to 8 streams may be defined in the stream ID fields.

In some embodiments, a UART stream transport message may be transmitted a DWord at a time via 32-bits per segment, which corresponds to a size of the alternate sector of each segment of the DL flit. The message length may in some embodiments be specified in the first Dword. The maximum length of the payload may in some examples be 32 DWords. The maximum length of the DL stream transport message may, in some examples, be 33 Dwords. The UART stream transport message may be transmitted continuously, i.e., without another DL message inserted between any of the UART stream transport message Dwords. In addition, in some examples, a UART stream credit update message may be provided to advertise credit availability from receiver to transmitter, which may be used as a function of the bidirectional protocol to dynamically determine the length of the UART stream transport message.

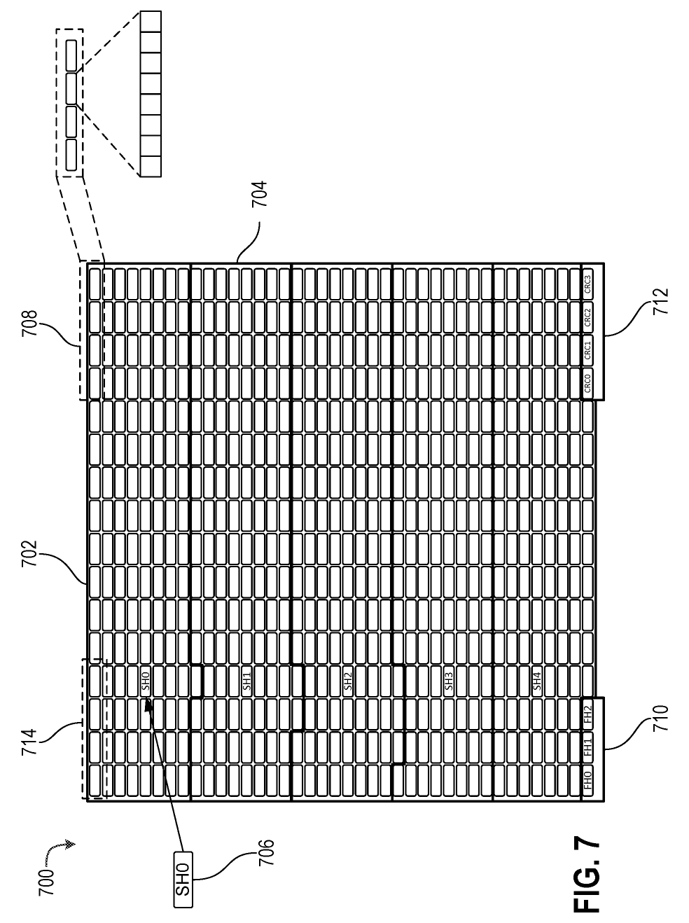

FIG. 7 illustrates an exemplary datagram 700 for carrying a UART message, according to some embodiments. The datagram 700 may be implemented in accordance with the techniques described herein, although others are possible. Datagram 700 may be implemented with any combination of components and/or subsystems of system 100, system 200, system 300, computer system 400, UART mode communication system 500, and communication system 600.

The datagram 700 may be a DL flit 702. The DL flit 702 may include n number of data segments 704. Each data segment 704 of the n number of data segments 704 may include a segment header 706 (shown as SH0, SH1, SH2, SH3, and SH4) and m number of sectors 708, with each sector 708 having a predefined number of bytes. For example, each sector may include 32-bytes. The segment header 706 may describe the data that starts in the data segment 704. The m number of sectors 708 may be for packing a data payload. The DL flit 702 may also include a flit header 710 and a cyclic redundancy check (CRC) 712 that may be appended to the DL flit 702 such that one or more of the data segments 704 may include less than m number of sectors 708 for packing the data payload. The flit header 710 may indicate the type of data and sequence number to aid in link level replay, and other information. The CRC 712 may be a calculated value characterizing the contents of the DL flit 702.

In some examples, each data segment 704 may include an alternative sector 714 including the predefined number of bytes, which may be indicated at the segment header 706. The alternative sector 714 may be configured to carry DL messages such as, for example, stream transport messages from the receiver/transmitter of the UART 502 of FIG. 5. The alternative sector 714 may have priority within the data segment. In this regard, if the segment header 706 indicates that a given data segment 704 includes the alternative sector 714, the data can be packed into the first sector of the given data segment 704, before the data payload or before any carry over of a data payload from a previous data segment.

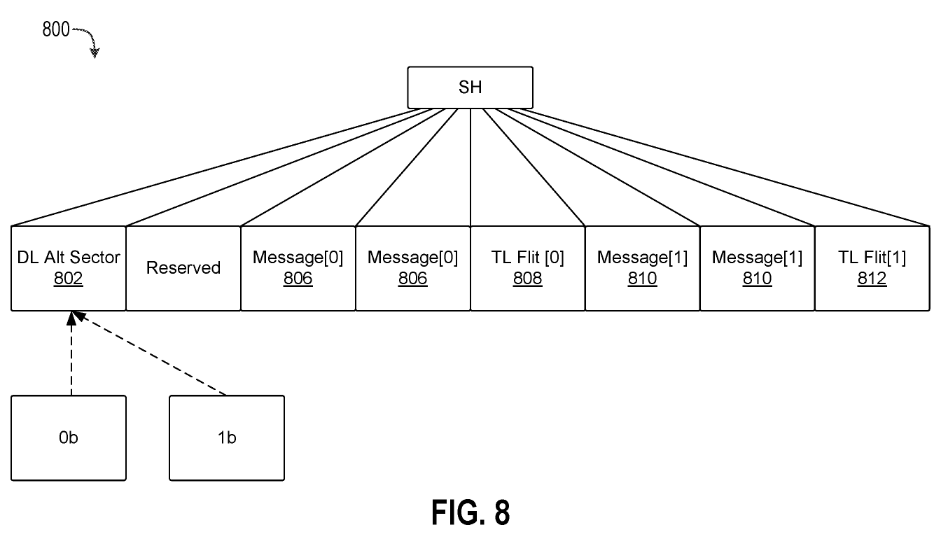

FIG. 8 illustrates an exemplary segment header 800 for indicating a content of a datagram including a UART message, according to some embodiments. The exemplary segment header 800 may be implemented in accordance with the techniques described herein, although others are possible. Segment header 800 may be implemented with any combination of components and/or subsystems of system 100, system 200, system 300, computer system 400, UART mode communication system 500, communication system 600, and datagram 700.

The segment header 800 may describe a TL flit sequence that starts in the segment. Up to two 64-byte TL flits may be contained in a TL flit sequence. The segment payload may be less than the 128-bytes, and some segments may contain alternative sectors, therefore some of the TL flit sequence may carry over into the next segment. The segment header may be 8B, or 32-bits. Referring to FIG. 8, illustrated are the field names for each bit of segment header 800. Segment header 800 may include DL alt sector 802 to indicate the presence of an alternative sector, reserved 804, message 806 to indicate the presence of the data payload, TL flit 808 to indicate the presence of the TL flit associated with message 806, message 810 to indicate the presence of the data payload, and TL flit 812 to indicate the presence of the TL flit associated with message 810. It should be appreciated that the segment header 800 and the fields of the segment header 800 are exemplary and not intended to be limiting, and the segment header 800 may include each of the fields depicted in FIG. 8, less fields, more fields, or any combination thereof, among other fields not described herein.

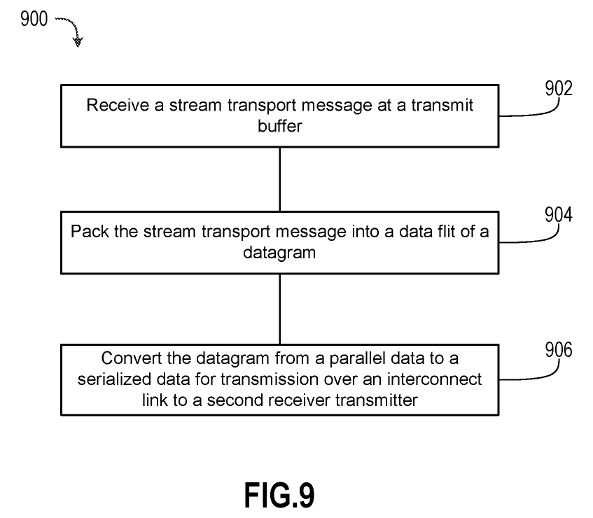

FIG. 9 is an exemplary method 900 for performing data exchange in accordance with an exemplary UART mode communication protocol, according to some embodiments. Method 900 may be implemented in accordance with the techniques described herein, although others are possible. Method 900 may be implemented with any combination of components and/or subsystems of system 100, system 200, system 300, system 400, UART mode communication system 500, and communication system 600. Method 900 may be implemented with datagram 700.

At 902, the method 900 may include receiving, by a first circuit, a stream transport message at a transmit buffer. The first circuit may include a first receiver transmitter. In some embodiments, the first receiver transmitter may be a first UART.

At 904, the method 900 may include packing, by the first circuit, the stream transport message into a data flit of a datagram. In some embodiments, packing, by the first circuit, the stream transport message into the data flit of the datagram may further include determining, by the first circuit, a size of the stream transport message, generating, by the first circuit, a first Dword characterizing the size of the stream transport message, and packing, by the first circuit, the first Dword and at least one second Dword into one or more data flits for transmission over the interconnect link to the second receiver transmitter.

In some embodiments, packing, by the first circuit, the first Dword and at least one second Dword into one or more data flits for transmission over the interconnect link to the second receiver transmitter may further include packing, by the first circuit, the first Dword and at least one second Dword of the stream transport message into one or more alternate sectors of the one or more data flits, and encoding, for each alternate sector including the stream transport message, a field value characterizing data being stored in the each alternate sector in a corresponding segment header. In some embodiments, each data flit may include a plurality of segments, and each segment may include an alternate sector.

At 906, the method 900 may include converting, by the first circuit, the datagram from a parallel data to a serialized data for transmission over an interconnect link to a second receiver transmitter.

The serialized data may be transmitted by the first circuit of a first computing device to a second circuit of a second computing device. In some embodiments, the method 900 may further include converting, by a second circuit, the serialized data received from the interconnect link to parallel data and sending the parallel data to the second receiver transmitter, unpacking, by the second circuit, the stream transport message from the data flit of the datagram, and storing, by the second circuit, the stream transport message at a receiver buffer. In some embodiments, the first circuit and the second circuit may exchange data messages as stream transport messages when performing firmware updates.

Techniques operating according to the principles described herein can be implemented in any suitable manner. While the foregoing disclosure sets forth some examples using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality.

Included in the discussion above are flowcharts showing steps and acts in accordance with some examples described herein. The processing and decision blocks of the flowcharts above represent steps and acts that can be included in algorithms that carry out these processes. Algorithms derived from these processes (or steps thereof) can be implemented as software integrated with and directing the operation of one or more single- or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flowchart(s) included herein do not depict the syntax or operation of any particular circuit or of any particular programming language or type of programming language. Rather, the flowchart(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that can be implemented and can be varied in implementations and embodiments of the principles described herein.

Accordingly, in some embodiments, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application. In other implementations, the functional facilities can be adapted to interact with other functional facilities in such a way as form an operating system, including the Windows® operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as system memory, accelerator memory, and/or system memory of the computer system 400 of FIG. 4 or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Unless otherwise noted, a first numeric value is “approximately” equal to a second numeric value if the first numeric value is within + 20%, + 10%, or + 5% of the second numeric value.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. An apparatus comprising:
a first circuit, the first circuit comprising a first receiver transmitter configured to asynchronously communicate with a second receiver transmitter of a second circuit over an interconnect link, and
wherein, in a transmit direction, the first circuit is configured to pack stream transport data into a first data flits of outgoing datagrams for serialized transmission of data from the first receiver transmitter to the second receiver transmitter over the interconnect link,
wherein, in a receive direction, the first circuit is configured to unpack stream transport data from a second data flits of incoming datagrams received as serialized data over the interconnect link from the second circuit of the second receiver transmitter.

2. The apparatus according to claim 1, wherein the first receiver transmitter comprises:
a transmit buffer for storing data messages to be packed into the first data flits and sent to the second receiver transmitter over the interconnect link, and
a receive buffer for storing data messages from the second data flits received over the interconnect link from the second receiver transmitter.

3. The apparatus according to claim 2, further comprising:
a first firmware agent,
wherein the first firmware agent exchanges data messages with a second firmware agent of the second receiver transmitter,
wherein the first firmware agent stores the data messages onto the transmit buffer, and the first firmware agent reads the data messages stored on the receive buffer.

4. The apparatus according to claim 3, wherein the first firmware agent and the second firmware agent exchange data messages to perform a firmware update.

5. The apparatus according to claim 3, further comprising:
a first serializer/deserializer (SERDES) coupled between the first receiver transmitter and the interconnect link,
wherein the first SERDES receives datagrams as parallel data and converts it to serialized data for transmission to a second SERDES coupled to the second receiver transmitter over the interconnect link.

6. The apparatus according to claim 1, wherein the first and second data flits comprise:
a header,
a cyclic redundancy check, and
a plurality of segments for storing a data payload,
wherein the stream transport data is stored in at least one segment of the plurality of segments.

7. The apparatus according to claim 6, wherein each segment of the plurality of segments comprises:
a segment header, and
an alternate sector,
wherein the stream transport data is stored in the alternate sector,
wherein, responsive to a given segment having data stored in the alternate sector, the segment header includes a field value characterizing data being stored in the alternate sector.

8. The apparatus according to claim 7, wherein the alternate sector is 32-bits, and
wherein each segment is 1024-bits.

9. The apparatus according to claim 1, wherein the stream transport data comprises:
a first Dword characterizing a size of the stream transport data, and
at least one second Dword characterizing a data payload of the stream transport data,
wherein the first Dword is determined based on a credit-based flow control for storing Dwords in a receiver buffer of the second receiver transmitter,
wherein the at least one second Dword is stored at a transmit buffer of the first receiver transmitter for the first circuit to pack into the first data flits.

10. A system for exchanging data messages between computing devices over an interconnect fabric in accordance with a protocol, the system comprising:
a first computing device comprising a first receiver transmitter, the first computing device coupled to the interconnect fabric; and
a second computing device comprising a second receiver transmitter, the second computing device coupled to the interconnect fabric;
wherein, in a transmit direction, the first receiver transmitter is configured to pack stream transport data from a transmit buffer into data flits of outgoing datagrams for transmission from the first receiver transmitter to the second receiver transmitter of the second computing device over the interconnect fabric,
wherein, in a receive direction, the first receiver transmitter is configured to unpack stream transport data from data flits of incoming datagrams received over the interconnect fabric from the second receiver transmitter of the second computing device and stores the stream transport data in a receive buffer.

11. The system according to claim 10, wherein the first computing device further comprises a first firmware agent, the second computing device further comprises a second firmware agent, and the first firmware agent is configured to exchange data messages with the second firmware agent; and
wherein the first firmware agent and the second firmware agent each store the data messages to be sent to the other of the first firmware agent and the second firmware agent onto the respective transmit buffer, and the first firmware agent and the second firmware agent each read the data messages stored on the respective receive buffer.

12. The system according to claim 11, wherein the first firmware agent and the second firmware agent exchange data messages to perform a firmware update.

13. The system according to claim 11, wherein the first computing device further comprises a first serializer/deserializer (SERDES) coupled between the first receiver transmitter and the interconnect fabric,
wherein the second computing device further comprises a second SERDES coupled between the second receiver transmitter and the interconnect fabric,
wherein the first SERDES receives the outgoing datagrams as parallel data and converts it to serialized data for transmission to the second SERDES over the interconnect fabric, and the second SERDES receives the serialized data over the interconnect fabric and converts the serialized data to the incoming datagrams as parallel data for storing into the respective receive buffer of the second receiver transmitter.

14. The system according to claim 13, wherein the data flits comprise:
a header,
a cyclic redundancy check, and
a plurality of segments for storing a data payload, each segment comprising:
a segment header, and
an alternate sector,
wherein stream transport data is stored in the alternate sector,
wherein, responsive to a given segment having data stored in the alternate sector, the segment header including a field value characterizing data being stored in the alternate sector.

15. The system according to claim 14, wherein the alternate sector is 32-bits, and
wherein each segment is 1024-bits.

16. The system according to claim 10, wherein stream transport data comprises:
a first Dword characterizing a size of the stream transport data, and
at least one second Dword characterizing a data payload of the stream transport data,
wherein the first Dword is determined based on a credit-based flow control for storing Dwords in a receiver buffer of the second receiver transmitter,
wherein the at least one second Dword is stored at the transmit buffer of the first receiver transmitter to pack into the data flits of the outgoing datagrams.

17. A method comprising:
receiving, by a first circuit, a first stream transport message at a transmit buffer;
packing, by the first circuit, the first stream transport message into a data flit of a first datagram; and
converting, by the first circuit, the first datagram from a parallel data to a serialized data for transmission over an interconnect link to a second receiver transmitter.

18. The method according to claim 17, wherein packing, by the first circuit, the first stream transport message into the data flit of the first datagram further comprises:
determining, by the first circuit, a size of the first stream transport message;
generating, by the first circuit, a first Dword characterizing the size of the first stream transport message; and
packing, by the first circuit, the first Dword and at least one second Dword into one or more data flits of the first datagram for transmission over the interconnect link to the second receiver transmitter.

19. The method according to claim 18, wherein packing, by the first circuit, the first Dword and the at least one second Dword into the one or more data flits of the first datagram further comprises:
packing, by the first circuit, the first Dword and the at least one second Dword of the first stream transport message into one or more alternate sectors of the one or more data flits of the first datagram, and
encoding, for each alternate sector including the first stream transport message, a field value characterizing data being stored in the each alternate sector in a corresponding segment header,
wherein each data flit comprises a plurality of segments, and each segment comprises an alternate sector.

20. The method according to claim 17, further comprising:
converting, by a second circuit, the serialized data received from the interconnect link to parallel data and sending the first datagram from the parallel data to the second receiver transmitter;
unpacking, by the second circuit, the first stream transport message from the data flit of the first datagram; and
storing, by the second circuit, the first stream transport message at a receiver buffer.
